(19) United States
(12) Patent Application Publication
(10) Pub. No.: US 2023/0410399 A1
(43) Pub. Date: Dec. 21, 2023

(54) SKELETAL ANIMATION IN EMBODIED AGENTS

(71) Applicant: SOUL MACHINES LIMITED, Auckland (NZ)

(72) Inventors: Mark Sagar, Auckland (NZ); Jo Hutton, Auckland (NZ); Tim Wu, Auckland (NZ); Tiago Ribeiro, Lisboa (PT); Pavel Sumetc, Auckland (NZ)

(21) Appl. No.: 18/035,534

(22) PCT Filed: Nov. 22, 2021
(86) PCT No.: PCT/IB2021/060792

§ 371 Date: May 5, 2023

(30) Foreign Application Priority Data
Nov. 20, 2020 (NZ) 770157

(51) Int. Cl. G06T 13/40; G06T 19/20; G06T 7/70

(52) U.S. Cl. CPC G06T 13/40; G06T 19/20; G06T 7/70; G06T 2219/2004; G06T 2219/2016

(57) ABSTRACT

Skeletal Animation is improved using an Actuation System for animating a Virtual Character or Digital Entity including a plurality of Joints associated with a Skeleton of the Virtual Character or Digital Entity and at least one Actuation Unit Descriptor defining a Skeletal Pose with respect to a first Skeletal Pose. The Actuation Unit Descriptors are represented using Rotation Parameters and one or more of the Joints of the Skeleton are driven using corresponding Actuation Unit Descriptors.

### TECHNICAL FIELD

Embodiments of the invention relate to computer graphics character animation. More particularly but not exclusively, embodiments of the invention relate to Skeletal Animation.

### BACKGROUND ART

One of the known methods to control the movement of a computer graphics character by an animator is to use parameters of the character's skeleton to drive its movement. Given a skeleton consisting of bones and joints which connect the bones, the parameters represent joint angles which define the local rotation of a particular bone with respect to adjacent bones. Once the values of these angles and bone lengths are defined, the resulting spatial position of each skeleton component can be calculated using the forward kinematics method.

The problem of defining skeleton parameters in animation can be approached through full body motion capture techniques or be manually specified by an animator.

If an animator wants to introduce some changes to the captured motion (secondary motions or movements that do not follow the laws of physics) the animator must manipulate the data to define the new values for the skeleton parameters. This is usually done manually through a process called animation authoring, which requires a lot of extra effort since any changes in parameters should be in accordance with movement mechanics.

Kinematic equations in the matrix form specify the motion mechanics of a skeleton. Those include the equations for a skeleton bone chain used to perform the forward kinematics computation. Changes in parameters leads to nonlinear changes in bone position and an animator would need to infer in advance what type of motion would be the result of particular parameters.

Other approaches use inverse kinematics wherein an animator specifies the spatial position and/or orientation of an ending bone in a skeleton bone chain (end effector in robot analogy). However, this approach requires the calculation of parameters across a series of bones, and if one wants to change the parameter values for a particular joint within the chain of bones individually, it must still be done manually.

Controlling skeleton animation directly through joint parameters has certain disadvantages and complications. Manually defining joint angles requires many trial-and-error iterations which usually can be accomplished only by experienced artists. To rotate a particular bone in a skeleton bone structure, one needs to change the parameter values for associated the joints (two parameters in 2D and three parameters in 3D). The most difficult part of this process for the artist is that the result of simultaneously changing two or more parameters is hard to predict and intuitively imagine. In other words, an artist needs to keep in mind relationships of motion mechanics to place a bone to a desired position.

Another issue arises when skeleton motion must be constrained, for example, to meet some physiologically realistic behaviour. This requires specifying individual boundaries for every parameter and any changes must meet these constrains.

Furthermore, manipulating with parameters in terms of angles leads to ambiguity since different values of joint angles could correspond to the same spatial position of the corresponding bone. This could introduce additional complexity in the process of skeleton animation.

### OBJECT OF INVENTION

It is an object of the invention to improve Skeletal Animation, or to at least provide the public or industry with a useful choice.

### BRIEF DESCRIPTION OF DRAWINGS

FIG. 1: Skeletal Base Pose with the example of Actuation Unit Descriptor controls set to zero;

FIG. 2: Example pose showing full activation of the “armAbductR” Actuation Unit Descriptor;

FIG. 3: Example pose showing partial activation of the “armAbductR” Actuation Unit Descriptor;

FIG. 4: Two example poses, “posePeaceSign” and “poseSit01”, generated using multiple Actuation Unit Descriptor values for each pose;

FIG. 5: Pose examples showing the result of blending two poses, “posePeaceSign” and “poseSit01”. Blending is performed using the Actuation Unit Descriptor values for each pose.

FIG. 6: Correspondence between a Skeletal Pose and a Actuation Unit Descriptor. Each joint of the skeletal system is associated with corresponding Rotation Parameters (rotation vector).

FIG. 7: Correspondence between a set of Skeletal Poses Pose_1 to Pose_m (various pose examples) and Actuation System.

FIG. 8: Schematic representation of the Actuation Unit Descriptor Combiner.

FIG. 9: Schematic representation of the Actuation Unit Descriptor Mapper 15.

FIG. 10: Schematic representation of the Animation Mixer.

FIG. 11: Schematic representation of the Actuation Unit Descriptor based Motion Interpolator and Predictor.

### DISCLOSURE OF INVENTION

Embodiments of the invention relate to skeletal animation. Embodiments of the invention relate

to a Actuation System, a Combiner, a Mapper, an Animation Mixer, and a Motion Interpolator and Predictor.

### Actuation System

The Actuation System addresses the problem of controlling the animation of digital characters (e.g virtual characters or digital entities) by manipulating the skeleton parameters. Rather than dealing with parameters directly in terms of angles, the Actuation System provides a way of controlling the skeleton of a Virtual Character or Digital Entity using Actuation Unit Descriptors (AUDs).

An Actuation Unit Descriptor is an animation control which is applied to change the rotation and/or translation values of one or more Joints in the skeletal system. Actuation Unit Descriptors may be Skeletal Poses represented by a kinematic configuration of the skeleton's joints. By activating a particular Actuation Unit Descriptor an animator can control the Skeleton animation.

The movable joints of the skeletal system include:
Ball and socket joints that allow movement in all directions, examples include your shoulder joint and your hip joint.
Hinge joint allowing opening and closing in one direction, along one plane, examples include your elbow joint and your knee joint.
Condyloid joints allowing movement, but no rotation, examples include your finger joints and your jaw.
Pivot joints, also called rotary joints or trochoid joints, allow one bone to swivel in a ring formed from a second bone, examples include the joints between your ulna and radius bones that rotate your forearm, and the joint between the first and second vertebrae in your neck.
Gliding joints for example the joint in your wrist.
Saddle joints for example the joint at the base of your thumb.

Actuation Unit Descriptors may be used in place of direct manipulation of global or relative rotation representations commonly used in Skeletal Animation. They may be thought of and designed as the kinematic result of performing a particular anatomical movement such as but not limited to flexion, extension, abduction, etc.

Actuation Unit Descriptors may be defined to be safely multiplied by an Activation Weight in the range of 0.0 to 1.0 in order to achieve some intermediate state. As long as the range of such Weights are kept between 0.0 and 1.0, the use of AUDs allows to abdicate of enforcing joint limits to the resulting skeletal motion, as the weight of 1.0 for a given AUD will result in the maximum limit of movement in a particular direction, for the corresponding Joint.

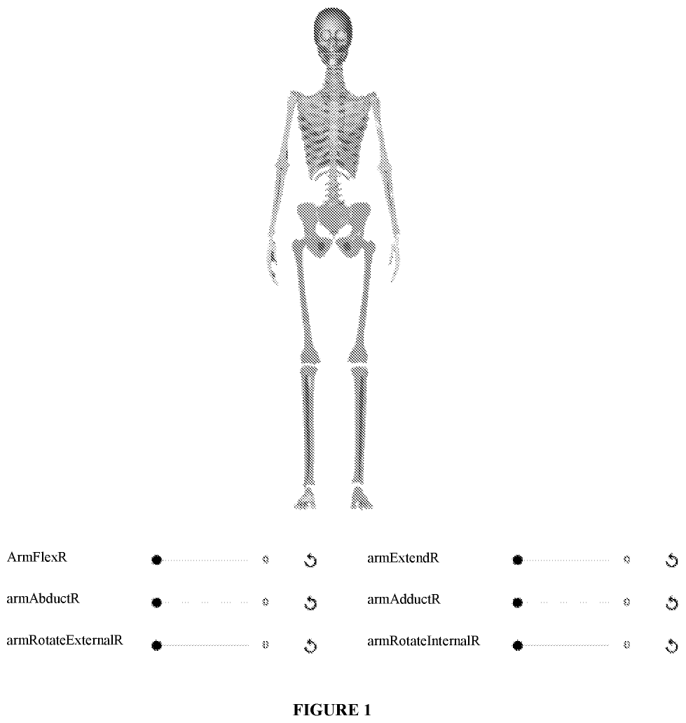

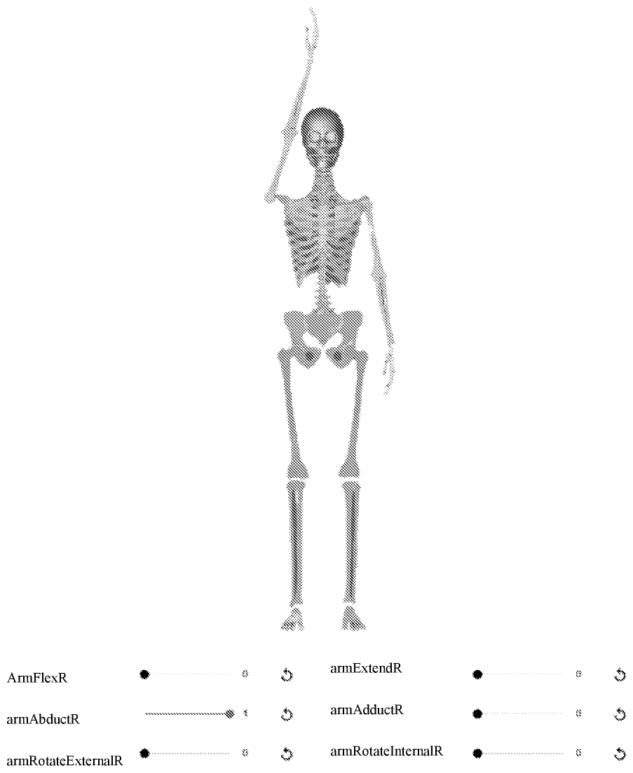

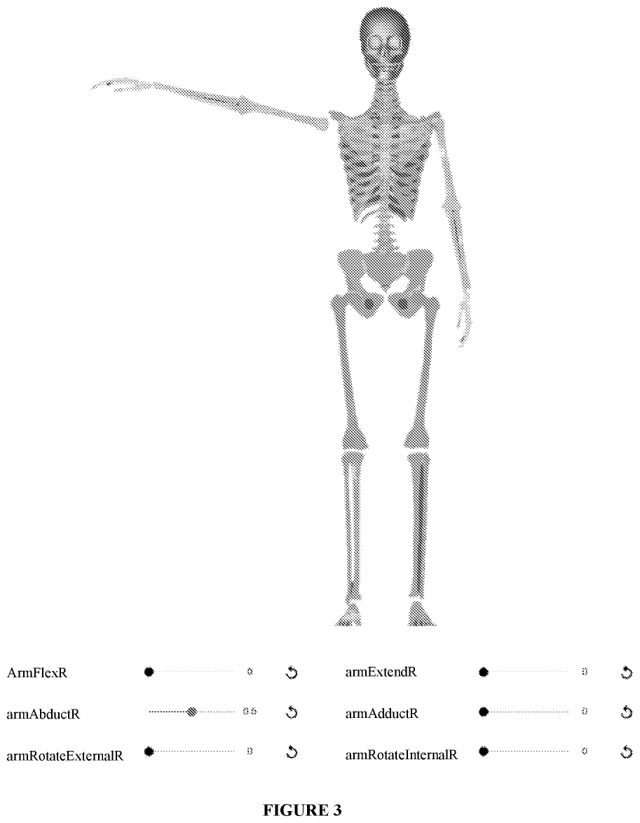

Considering as an example the AUD for “armAbductR”, depicted in FIG. 2, which specifies the pose of maximum abduction of the glenohumeral joint, a weight of 0.0 would represent no abduction at all (FIG. 1), 1.0 would bring the arm to a pose corresponding to the maximum abduction of the joint (FIG. 2), while 0.5 would result in the arm lifted half-way (FIG. 3).

In a given embodiment, the activation of a single Actuation Unit Descriptor is represented by a single floating-point value which allows it to represent 2D and 3D rotations of one or multiple joints in a compact format in comparison to typical matrix or even quaternion representations.

In some embodiments, Actuation Unit Descriptors are biologically inspired, i.e. resemble or mimic the muscles or muscle groups of biological organisms (e.g. animals, mammals or humans). In other embodiments, Actuation Unit Descriptors may be configured to replicate a biological organism's muscles as closely as possible. The effect of Actuation Unit Descriptors may be based on actual anatomical movements in which a single or multiple Joints are driven by the activation of either a single muscle or a group of muscles.

Actuation Unit Descriptors may be Joint Units, Muscle Units, or Muscle Unit Groups.

A Joint Unit is a mathematical joint model that represents a single anatomical movement for a single limb or bone, such as single arm, forearm, leg, finger bone, vertebra etc. Joint Units may or may not correspond to movements that can be individually performed by the given limb or bone in an intentional and anatomically correct manner.

A Muscle Unit is a conceptual model that represents a single anatomical movement performed by a muscle or group of muscles on a single or multiple Joints and corresponds to anatomically correct movements.

Muscle Unit Groups represent the activity of several Muscle Units working together to drive a particular anatomically-correct motion across multiple Joints.

Thus Actuation Unit Descriptors may be configured as one or more of the following:
The motion of a single joint (e.g. single interphalangeal flex; single vertebrae rotation), in which case the Actuation Unit Descriptors represent Joint Units.
Single or multiple muscles moving a single joint (e.g. elbow flex; arm-abduct), in which case the Actuation Unit Descriptors represent a Muscle Unit Group.
Single or multiple muscles moving multiple joints (e.g. flexor digitorum profundus; neck flex), in which case the Actuation Unit Descriptors represent Muscle Units.
Multiple Muscle Units moving multiple joints (e.g. full spine; scapulohumeral rhythm), in which case Actuation Unit Descriptors represent Muscle Unit Groups.

A given Actuation Unit Descriptor may simultaneously represent a Joint Unit and a Muscle Unit, or a Muscle Unit and a Muscle Unit Group given that the Muscle Unit Group combines one or more Muscle Units, and that a Muscle Unit is a specialization of the Joint Unit.

In a given embodiment, each Joint of a Skeleton is associated with a corresponding Rotation Parameter of an Actuation Unit Descriptor.

In a given embodiment, if a skeleton contains n joints, each Actuation Unit Descriptor 3 used for driving the skeleton is represented as a structure having n sectors, each sector containing the Actuation Unit Descriptor component for each joint in terms of Rotation Parameters.

The Rotation Parameters, θ described herein are primarily rotation vectors, however the invention is not limited in this respect. Any suitable rotation representation that can be linearly combined may be used, including, but not limited to, Euler angles or rotation vectors.

Where the Rotation Parameter is represented as a rotation vector, the vector's magnitude is the rotation angle, and its direction is a line about which rotation occurs. Given a vector v, the change 8v is related to rotation vector r by δv=r×v.

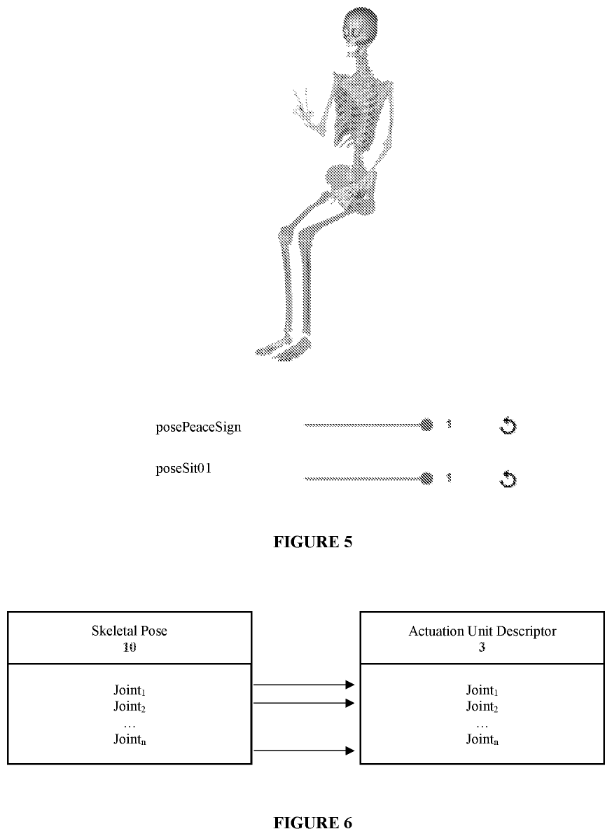

FIG. 6 shows the correspondence between a Skeletal Pose having a set of Joints Joint₁ to Jointₙ and the Actuation Unit Descriptor consisting of Rotation Parameters 4 corresponding to each Joint (Joint₁ to Jointₙ).

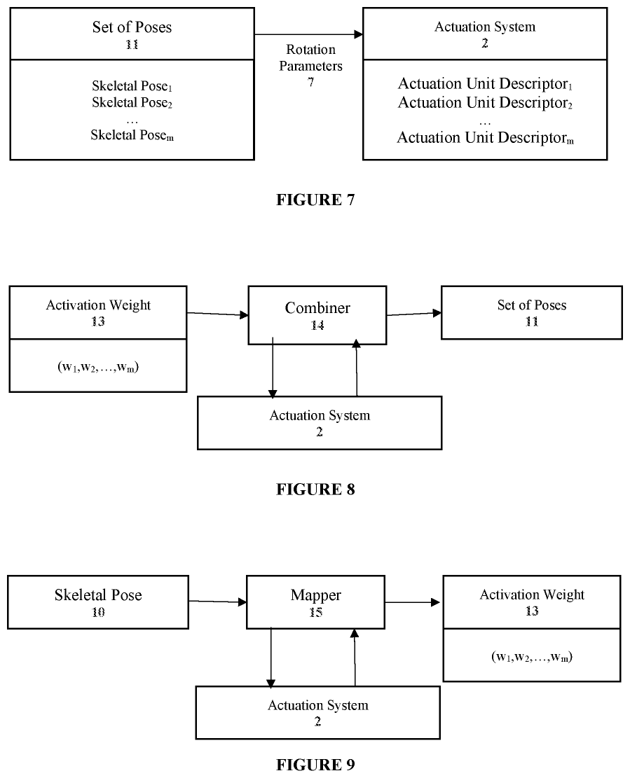

From a mathematical standpoint, Actuation Unit Descriptors can be viewed as a basis into which any pose can be decomposed. FIG. 7 shows the correspondence between a set of Skeletal Poses Pose₁ to Poseₘ and the Actuation System 2.

The Actuation System allows animators to control Skeletal Poses via an improved interface using intuitively meaningful parameters. For example, rather than figuring out which angle based parameters for a particular joint needs to be specified to lift an arm of a Virtual Character or Digital Entity, the animator can change just a single parameter which is the Activation Weight for predefined Actuation Unit Descriptor. Manipulating with Actuation Unit Descriptors significantly simplifies the process of controlling skeleton animation.

A database for the Actuation System may store a set of Rotation Parameters for a given skeleton system.

### Combiner

The Combiner 10 combines individual Actuation Unit Descriptors to generate complex Skeletal Poses. FIG. 8 shows a representation of the AUD Combiner using Activation Weights to generate a new Skeletal Pose.

Once a set of Actuation Unit Descriptors is created, an animator can compose any complex pose through a linear model, such as:

$$\begin{matrix}\begin{matrix}P = {U}_{0} + {\sum }_{k = 1}^{m} {w}_{k} Δ {U}_{k} , & Δ {U}_{k} = {U}_{k} - {U}_{0} ,\end{matrix} \\ {U}_{k} = ( \begin{matrix}{r}_{1}^{k} \\ {r}_{2}^{k} \\ … \\ {r}_{n}^{k}\end{matrix} )\end{matrix}$$

where P is the resulting pose, U₀ is the Skeletal Base Pose, Uₖ is the Actuation Unit Descriptor with Rotation Parameters (rotation vectors) rⱼ, and wₖ are the weights. An animator controls a new Skeletal Pose through the parameters wₖ and P=P(w).

The summation of Actuation Unit Descriptors is equivalent to summation of rotation vectors which produces a vector with rotation properties. A rotation vector can be linearised with additive and homogeneity properties, for which adding two rotation vectors together results in another rotation vector. This is not the case for rotation matrices and quaternions. Generally, this vector sum is not necessarily equivalent to applying a series of successive rotations. Given a vector v and two rotation vectors r₁ and r₂, the result of applying two successive rotations to the vector v is obtained through:

$${v}_{{rot}_{1}} = v + {r}_{1} \times v ,$$

$$\begin{matrix}{v}_{{rot}_{33}} = {v}_{{rot}_{1}} + {r}_{2} \times {v}_{{rot}_{1}} = v + {r}_{1} \times v + {r}_{2} \times ( v + {r}_{1} \times v ) \\ = v + ( {r}_{1} + {r}_{2} ) \times v + {r}_{2} \times {r}_{1} \times v \\ \approx v + ( {r}_{1} + {r}_{2} ) \times v\end{matrix} ,$$

where in the last line the quadratic term is dropped.

In the linear approximation, the combination of two rotations can be represented as a sum of two rotation vectors, so the model is applicable under the assumption of linearity. To meet this assumption, rotation vectors are small or zeroth or collinear.

In a given embodiment, the Actuation Unit Descriptors are specified so that each individual Actuation Unit Descriptor contains only one nonzero row not overlapping with other Actuation Unit Descriptor which means that the associated generic muscle drives only one single joint and the model becomes exact.

Nevertheless, even if this assumption does not hold, the model still generates a pose defined by meaningful rotation vectors when applied, so defining a Actuation Unit Descriptor which drives several joints is acceptable.

One advantage of the proposed model is its linearity which allows applying various linear methods to manipulate with skeleton parameters, wₖ (such as a Mapper 15). The model can be used to apply physiological limits to the generated pose. For example, by constraining AUD Activation Weight (weights) to be 0≤wₖ≤1, any combination of Actuation Unit Descriptors is prevented from going beyond the values specified in the Actuation Unit Descriptor.

In addition, the resulting Skeletal Pose combined this way produces results that are perceived as more intuitive by artists and easier to work with due to its commutative property.

For example, M=R(r₁+r₂)=R(r₂+r₁) produces more intuitive results than M=R1×R2 or than M=R2×R1, where M is the resulting rotation matrix, R₁ and R₂ are the two rotations under consideration, r₁ and r₂ are their rotation vector form and R is the transformation from the rotation vector to the rotation matrix.

An Actuation Unit Descriptor Combiner computer-based software library takes the Actuation Unit Descriptor data set and a set of corresponding Activation Weight values. The Actuation Unit Descriptor Combiner library implements functions for linearly combining the given Actuation Unit Descriptors based on the given Activation Weight values. The Combiner outputs the combined Skeleton Pose rotations as a set of rotation representation which may take any form such as a matrix, quaternion, Euler angles, etc.

In other embodiments, the linear model described above is substituted by a nonlinear equation composing of incremental and combination Actuation Unit Descriptors. For example, the model described in patent application WO2020089817-MORPH TARGET ANIMATION, also owned by the present applicant and incorporated by reference herein, may be used.

### Mapper 15

FIG. 9 shows a schematic representation of the Mapper 15. The Mapper converts existing Skeletal Poses expressed in terms of Rotation Parameters θ, to a pose expressed in terms of muscle activations, wₖ, i.e., parameters of the Actuation Unit Descriptors. The Mapper 15 may convert poses obtained from motion capture techniques, or created using character animation or other Skeletal Pose processing software.

The Mapper 15 solves a least squares problem. Given a pose expressed through any rotation representation, P*(θ), a transformation is performed to convert it into Rotation Parameters (rotation vectors). This results in obtaining a structure P*(r) having n sectors where each sector is a rotation vector associated with the corresponding joint. Then, a least squares problem of the following form is to be solved

$${min}_{{w}_{k}} {‖ {\sum }_{k = 1}^{m} {w}_{k} Δ {U}_{k} - Δ {P}^{*} ‖}_{{L}_{2}} + μ {\sum }_{k = 1}^{m} {‖ {λ}_{k} {w}_{k} ‖}_{{L}_{1}}$$

where ΔUk=Uₖ−U₀ are the Actuation Unit Descriptors and ΔP*=P*−U₀ is the difference between the target pose and the base pose. Coefficient λi is a hyperparameter that penalizes the specified Actuation Unit Descriptor weights. By solving the least square problem, the pose P* is decomposed into Actuation Unit Descriptors, and the AUD Activation Weight, wₖ, are obtained. Muscle Activation Weights are parameters controlling the Skeletal Pose, so P*=P*(w). The second term is a L1-regularisation term that imposes sparsity on the final solution.

The Mapper 15receives inputs including: an Actuation System data set, the least squares solver settings, constraints on weights and a target pose expressed in terms of rotation parameters for the skeleton with same topology as one for AUD data set.

The Mapper 15 first implements a function for converting the target Skeletal Pose rotation parameters in any rotation representation into rotation vector representation and a second function for solving the least square problem. The Mapper 15 may output a set of Actuation Unit Descriptors as a result.

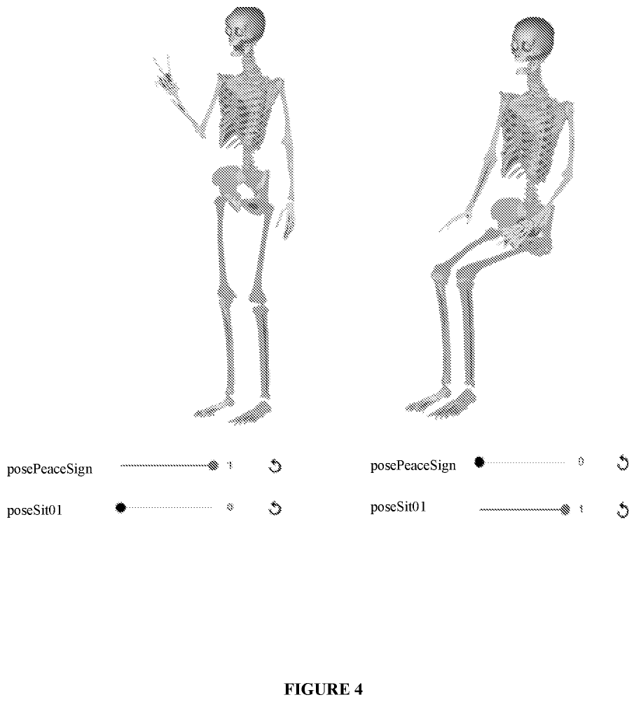

FIG. 1 to FIG. 5 show examples of blending animation frames using Actuation Unit Descriptor controls (shown for each example).

### Animation Mixer

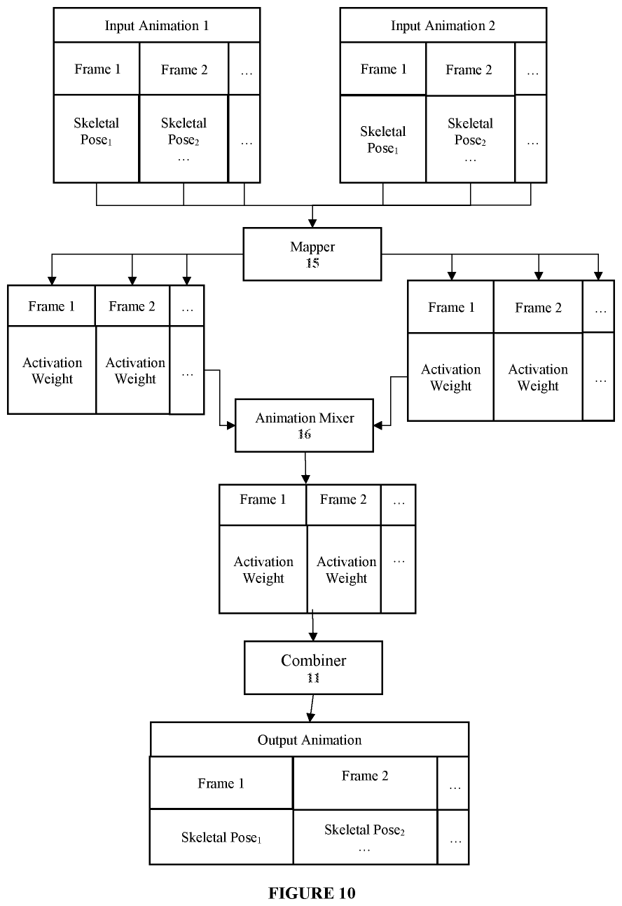

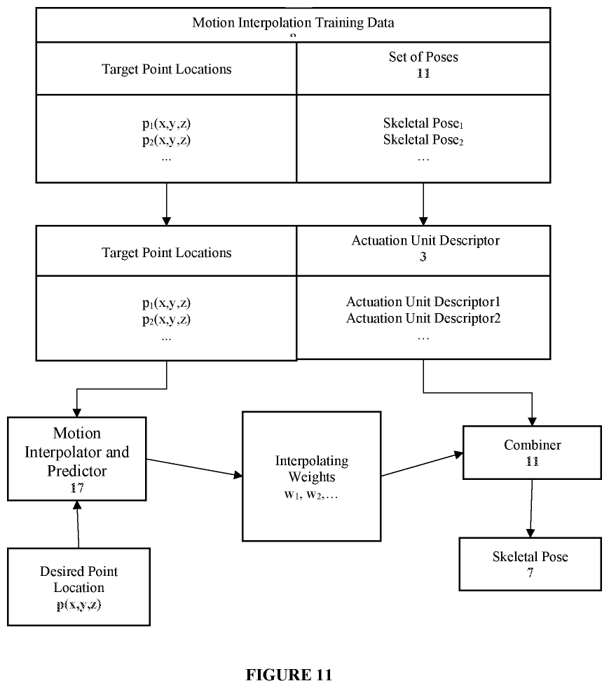

FIG. 10 shows a schematic representation of the Animation Mixer. The Animation Mixer allows the Actuation Unit Descriptors from a plurality of source animations to be blended together in order to generate a new blended animation, also represented via Actuation Unit Descriptors.

Given an animation in the form of a sequence of key frames representing successive poses of a character movement, each frame is specified as a set of Actuation Unit Descriptor weights defining a particular pose through the Actuation Model. Mixing a number of animations may be implemented by combining the Actuation Unit Descriptor weights of the corresponding key frames from these animations. The frame weights combination may be performed through various formulas. For example, having N animations of Mₙ frames each, where each frame k is a set of m weights, and each weight j of frame k of animation i is represented as the resulting mixed animation weights W can be calculated using one of the following formulas:

$${W}_{k}^{j} = {max}_{i} {}_{}^{i} {w}_{k}^{j} ,$$

$${W}_{k}^{j} = {\sum }_{i = 1}^{N} {}_{}^{i} {w}_{k}^{j} ,$$

$${W}_{k}^{j} = {\sum }_{i = 1}^{N} {c}_{i} ( {}_{}^{i} {w}_{k}^{j} )$$

The coefficient cᵢ may be of a different form, for example,

$${c}_{i} = \frac{{α}_{i} ( {}_{}^{i} {w}_{k}^{j} )}{{\sum }_{i = 1}^{N} {α}_{i} ( {}_{}^{i} {w}_{k}^{j} )} .$$

where αᵢ is a parameter controlling the contribution of a particular animation to the mixed animation.

The Animation Mixer receives as input the animations which may each be represented through a structure containing one sector per key frame, each sector containing the AUD weights to be applied to each AUD on that given frame. A function which implements a formula for mixing the matrices elements may be implemented. The Animation Mixer may output a structure containing one sector for each mixed key frame, where each sector contains the resulting Actuation Unit Descriptor weights for the corresponding frame. Each component of the system can be used by itself in combination with other algorithms. The Animation Mixer could incorporate various frame mixing formulas beyond the present disclosure.

Actuation Unit Descriptors can be blended together indefinitely through the use of the Animation Mixer without causing noticeable blending artifacts.

### Motion Interpolator and Predictor

FIG. 11 shows a schematic representation of the Motion Interpolator. Here target point locations and desired point location could be, for example, coordinates of an end effector location in three-dimensional space. The AUD based approach can be used in motion interpolation techniques, for example, in arm reaching motion to allow a character to point an arm to a user-specified object within reaching distance. The arm motion is generated by interpolating the example poses. An artist creates a set of example poses with the arm pointing at a variety of target space locations. In practice, this could be an array of points which sparsely covers the character's surrounding space within arm reaching distance. As a result, each example pose is associated with a pair: Actuation Unit Descriptor for the particular pose and a point p=(x; y; z) which is a coordinate of the end effector location in three dimensional space (apex position of the pointing finger).

As such, the example motion is parameterized in three-dimensional space by points P. These points represent nodes of an interpolation grid with the values of the Actuation Unit Descriptors. To control a reaching motion, a user specifies the desired location of an end effector in the parameter space (point coordinates at which the character points). The run-time stage produces the reaching pose by blending the nearby examples. An interpolation system computes interpolation weights which, in turn, are used as the Activation Weights for the AUD Combiner. The Actuation Unit Descriptors are combined using these Activation Weights resulting in the pose configuration corresponding to the character pointing at the specified location. As an interpolation system, one can use, for example, meshless methods (radial basis function approach) or mesh-based method (tensor spline interpolation).

Both the linearity and commutative properties of the Actuation Unit Descriptors are desirable for motion matching and predictive Machine Learning (ML) models since they allow applying various model configuration and training strategies. For example, the arm reaching motion described above can be implemented through ML as follows. Having a ML model configuration consisting of the input feature vector, hidden layers and output vector, one can use the target point location as an input feature vector and the corresponding Actuation Unit Descriptor as an output. By training the model on the pre-created pose examples, the model learns how to associate the end effector location in three-dimensional space (input) with the pose configuration (output). Once it has been trained, the model can match a desired target point location to a Skeletal Pose configuration.

### INTERPRETATION

The inventions described herein can be applied to all geometry controls that are based on manipulating with character skeleton parameters. On top of examples presented here, it can be used for controlling poses of non-human characters and creatures. Each component of the system can be used by itself or in combination with other algorithms. The methods and systems described may be utilised on any suitable electronic computing system. According to the embodiments described below, an electronic computing system utilises the methodology of the invention using various modules and engines. The electronic computing system may include at least one processor, one or more memory devices or an interface for connection to one or more memory devices, input and output interfaces for connection to external devices in order to enable the system to receive and operate upon instructions from one or more animators or external systems, a data bus for internal and external communications between the various components, and a suitable power supply. Further, the electronic computing system may include one or more communication devices (wired or wireless) for communicating with external and internal devices, and one or more input/output devices, such as a display, pointing device, keyboard or printing device. The processor is arranged to perform the steps of a program stored as program instructions within the memory device. The program instructions enable the various methods of performing the invention as described herein to be performed. The program instructions may be developed or implemented using any suitable software programming language and toolkit, such as, for example, a C-based language and compiler. Further, the program instructions may be stored in any suitable manner such that they can be transferred to the memory device or read by the processor, such as, for example, being stored on a computer readable medium. The computer readable medium may be any suitable medium for tangibly storing the program instructions, such as, for example, solid state memory, magnetic tape, a compact disc (CD-ROM or CD-R/W), memory card, flash memory, optical disc, magnetic disc or any other suitable computer readable medium. The electronic computing system is arranged to be in communication with data storage systems or devices (for example, external data storage systems or devices) in order to retrieve the relevant data. It will be understood that the system herein described includes one or more elements that are arranged to perform the various functions and methods as described herein. The embodiments herein described are aimed at providing the reader with examples of how various modules and/or engines that make up the elements of the system may be interconnected to enable the functions to be implemented. Further, the embodiments of the description explain, in system related detail, how the steps of the herein described method may be performed. The conceptual diagrams are provided to indicate to the reader how the various data elements are processed at different stages by the various different modules and/or engines. It will be understood that the arrangement and construction of the modules or engines may be adapted accordingly depending on system and animator requirements so that various functions may be performed by different modules or engines to those described herein, and that certain modules or engines may be combined into single modules or engines. It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device. The methods described herein may be implemented using a general-purpose computing system specifically programmed to perform the described steps. Alternatively, the methods described herein may be implemented using a specific electronic computer system such as a data sorting and visualisation computer, a database query computer, a graphical analysis computer, a data analysis computer, a manufacturing data analysis computer, a business intelligence computer, an artificial intelligence computer system etc., where the computer has been specifically adapted to perform the described steps on specific data captured from an environment associated with a particular field.

1-24. (canceled)

25. An Actuation System for animating a Virtual Character or Digital Entity comprising:
a processor;
a memory communicatively coupled to the processor, wherein the memory stores:
values defining a plurality of Joints associated with a Skeleton of the Virtual Character or Digital Entity, and
at least one Actuation Unit Descriptor defining respective Skeletal Poses with respect to a first Skeletal Pose; and
program instructions stored in the memory and that, upon execution by the processor, cause the processor to:
drive the Actuation Unit Descriptor using Rotation Parameters and one or more of the Joints of the Skeleton using corresponding Actuation Unit Descriptors multiplied by corresponding Activation Weights.

26. The Actuation System of claim 25, wherein the first Skeletal Pose is a Skeletal Base Pose.

27. The Actuation System of claim 26, wherein Rotation Parameters are representations of rotation configured to combine linearly.

28. The Actuation System of claim 27, wherein each Actuation Unit Descriptor is configured to drive a single Joint.

29. The Actuation System of claim 27, wherein each Actuation Unit Descriptor is configured to drive multiple Joints.

30. The Actuation System of claim 29, wherein applying a rotation transformation of each Actuation Unit Descriptor to the skeleton produces a motion of skeleton parts reflective of contraction or relaxing one or more muscles in a biological system having a skeletal topology similar to the skeletal topology of the Virtual Character or Digital Entity.

31. The Actuation System of claim 30 further comprising an Actuation Unit Descriptor Combiner for controlling Virtual Character or Digital Entity animation, wherein the Actuation Unit Descriptor Combiner is configured to combine a plurality of Actuation Unit Descriptors using a linear equation.

32. The Actuation System of claim 31 further comprising an Actuation Unit Descriptor Mapper for estimating parameter values for the Actuation Unit Descriptor Combiner for a given pose parameterized in terms of joint angles, which comprises:
converting given pose parameters to a set of rotation vector values associated with rotation of skeleton parts around particular joints,
constructing a structure containing the rotation parameters associated with each joint of the skeleton, and
obtaining Actuation Unit Descriptor weights through solving a least squares problem.

33. A method of generating an animation of a Skeleton of a Virtual Character or Digital Entity comprising:
defining a plurality of Actuation Unit Descriptors as animation controls configured to change rotation and/or translation values of one or more Joints of the Skeleton;
converting the plurality of Actuation Unit Descriptors into Rotation Parameters;
using the Rotation Parameters to blend and convert two or more input animations to an Actuation Unit Descriptor space to generate one or more animations; and
composing and playing back the one or more animations on a joint-driven skeleton using any rotation representation.

34. A method for animating arm reaching in a Virtual Character or Digital Entity comprising:
receiving a desired location of an end effector of an arm of a Virtual Character or Digital Entity in a parameter space;
retrieving example poses, each associated with a coordinate of an end effector and pose Actuation Unit Descriptors;
generating interpolated poses by interpolating poses using the example poses as interpolation nodes, wherein interpolation is performed in parameter space with a coordinate of an end effector as a parameter and pose Actuation Unit Descriptors as values; and
animating the arm reaching using the interpolated poses.

35. The method of claim 34 wherein interpolation uses a meshless or mesh base technique that represents solutions through a weighted combination of interpolation node values.
